(19) United States
(12) Patent Application Publication
(10) Pub. No.: US 2019/0290036 A1
(43) Pub. Date: Sep. 26, 2019

(54) ILLUMINATED COLOR OF LIQUID CONTENTS

(71) Applicants: Eric Campos, Fullerton, CA (US); Philip George Franklin, Fullerton, CA (US)

(72) Inventors: Eric Campos, Fullerton, CA (US); Philip George Franklin, Fullerton, CA (US)

(21) Appl. No.: 15/934,627

(22) Filed: Mar. 23, 2018

(51) Int. Cl. A47G 19/22; F21V 33/00

(52) U.S. Cl. CPC A47G 19/2227; F21Y 2115/10; A47G 2019/2238; F21V 33/0036

(57) ABSTRACT

A method for creating the appearance of a glowing liquid in a drinking container by placing a liquid into the container, placing a light source proximate to the container, placing a plurality of dye molecules into the container, in which the dye molecules have wavelengths which absorb photons emitted from the light source, the light source emitting photons, which are absorbed into the dye molecules which creates the appearance that the liquid itself is glowing.

### TECHNICAL FIELD

The present invention comprises a method of using a light source in combination with a liquid creating an illuminated and glowing liquid in a beverage container.

### BACKGROUND

There are cups in the marketplace that are manufactured using molded clear plastic, having LED's as a light source located in the base of the cup. Besides the LEDs, there is a means of electrical power, battery or batteries, and a means of power control, a simple switch, or a switch and a microprocessor used to control the LEDs to create patterns of light, a “light show”. These cups are used to hold clear or lightly-tinted liquids, and the LEDs are then flashed on and off in order to function as a novelty drinking cup at parties, meals, restaurants and/or bars.

While the LEDs are often multi-color, therefore emitting various colors of light over time, “dancing colors of light”, there is a limitation to the lighting effect: When the cup is viewed from the side or straight on, the LEDs are clearly seen as points or sources of light, and the liquid itself does not light-up, or “glow”. If the end-user, “drinker”, is content that the LEDs in the cup provide some entertainment and novelty of the experience of using the cup to hold a drink, that is fine. Furthermore, the end-user must also be content in that the LEDs are the brightest light sources when the cup is viewed, and the liquid contents itself does not glow or give the impression that it is glowing.

If the end-user desires to give the impression that the liquid contents within the cup are in fact fluorescent or luminescent, the LEDs cannot appear as bright point sources of illuminating light. To accomplish de-emphasizing, the LEDs as point sources of the light, the liquid itself must appear to glow and diffuse the emitted light from the LEDs.

### SUMMARY OF THE INVENTION

The main embodiment of the invention is to present a lighting effect, such that when viewed from near or far, the liquid contents within a container appear to be illuminating and glowing, as opposed to the effect that the container contents are slightly lighted.

The liquid contents of the container must appear to light-up and glow, that the liquid contents in the container must scatter and redirect the light rays (photons) emanating and concentrated from the bottom of the container, to the sides and as many angles as possible, resulting in the appearance that the liquid itself is glowing.

Using optical reflection or diffraction techniques on the light rays to redistribute the light energy emanating from the bottom of the container, to give the appearance that the liquid contents are glowing has been tried, however the resulting lighting effect, as to giving the appearance that the liquid contents are glowing, is very weak, and does little to show that the LEDs at the bottom of the container are optically hot.

The invention herein, employs dyes and molecular chemistry techniques, such that light photonic energy emanating from the LEDs at the bottom of the container are first absorbed by key dye molecules distributed within the liquid contents, and then the dye molecules, later using the captured photonic energy to release a new photon from the dye molecule, literally resulting in the liquid contents glowing.

### BRIEF DESCRIPTION OF THE DRAWINGS

FIG. 1 is a graphical representation of a typical dye molecule;

FIG. 2A is an overview illustration of one of the three possible results of a dye molecule;

FIG. 2B is an overview illustration of the second of the three possible results of a dye molecule being energized or struck by a photon;

FIG. 2C is an overview illustration of the third of the three possible results of a dye molecule being energized or struck by a photon.

FIG. 3 is an illustration of the same type of dye molecule;

FIG. 4 is an illustration of a container with a water-based liquid

### DETAILED DESCRIPTION

“Wavelength” is scaled for convenience in nanometers [10⁻⁹ meters], and is directly related to what we detect as humans, as “color of the light”. Some prefer “frequency” which is the inversion of wavelength [1/wavelength] and hence also related to “color of the light”. This description will continue to use “wavelength” herein. Additionally, “Ray”, “Light Ray”, or “Light Rays”, are used herein to refer to a multiplicity of photons in transit from a source, and not intended to be limiting in scope. Furthermore, the use “LED” (Light Emitting Diode) as a general class of semi-conducting devices in the broadest sense. As a means of illustration, but without limitation to include “OLEDs” (Organic Light Emitting Diodes), Quantum-Well Emitter LEDs, LEDs that employ lasing techniques, light emitters that use nano-scale resonation techniques, and LEDs that employ Quantum Dot techniques (“OLEDs).

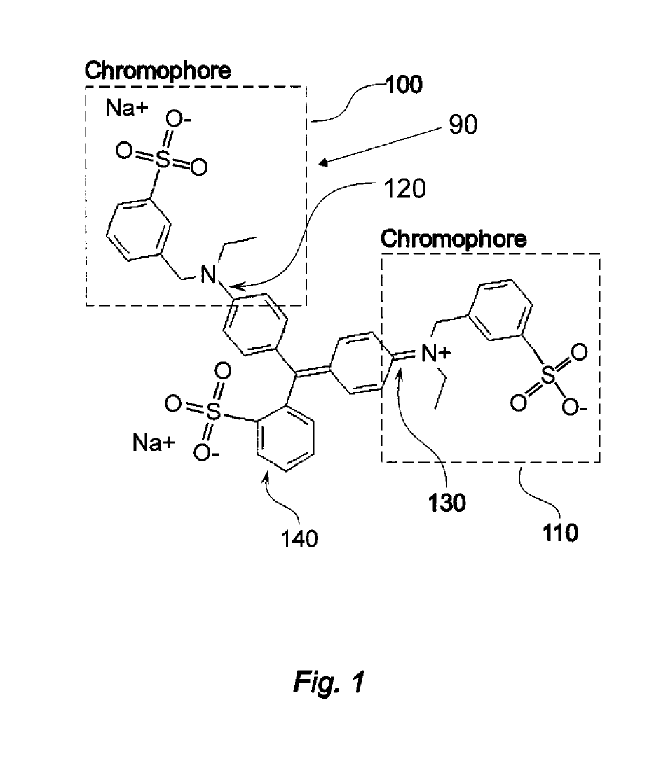

FIG. 1 is a graphical representation of a typical dye molecule (90). This dye molecule is generic in illustration, and not to be used to express required configuration of a dye molecule in the invention. The molecule (90) is a Blue Dye molecule with an optical wavelength of 435-480 nanometers.

The dye molecules to be used are those known to be benign to the health of the user. Specifically, the drinks, if employing dyes that are added to, and not already naturally occurring in the drink, to be those known and accepted as safe for human consumption by the Federal Drug Administration, such as those that are listed and specified under the 1938 Federal Food, Drug and Cosmetic Act. Also, there are dyes recognized and approved for human consumption by other federal and world controlling authorities.

Molecule (90) has a chemical base, and contains two Chromophores (100) and (110) attached to that chemical base. A Chromophore is a subsection of a dye molecule that can receive photonic energy from an outside source, and then capture and hold that photonic energy by resonating certain chemical bonds within the molecule. Chromophores (100) and (110) are “tuned” to specific optical wavelengths (435-480 nanometers in this example). The base atomic structure of the dye molecule (140) is static in that bonds do not change and the atoms are passive and do not participate in reference to determine wavelength processing. Other dye molecules share this same atomic (chemical) base.

Chromophores (100) and (110) determine what wavelengths of light and photons the molecule will respond to, and the wavelength of the photon that will be emitted from the molecule. As an analogy to an electronic circuit, in effect, the Chromophores (100) and (110) can be thought of as the sections of tuned circuits, that in a radio circuit determines which radio wavelength or wavelength the radio is listening to.

FIG. 1 shows Chromophores (100) and (110) bonded to the base of molecule (90) via single or double bonds. In this blue dye molecule, while static (not energized), one Chromophore has a single bond, and the other Chromophore has a double bond. It is arbitrary as to which Chromophore initially has a single bond, and which has the double bond. These bonds (120) and (130) will exchange (resonate between) single and double bonds when the molecule is energized. In FIG. 1, the upper Chromophore (100) has an associated single-bond (120) shown, while the lower Chromophore (110) has an associate double-bond (130) as shown. It is in the process of the resonating (cycling single-to-double-to-single, etc.) bonding between the two Chromophore sections that photonic energy, if within the proper wavelength spectrum, is stored for later use.

When a photon (for example from a light ray) enters the molecule and strikes a Chromophore, one of two reactions can occur: if the entering photonic energy is within the band of acceptable wavelengths, that the Chromophore will resonate to, then the photonic energy will be captured by the Chromophore. Or, should the entering photonic energy be outside of the band of acceptable wavelengths, the Chromophore will not resonate and the photonic energy will not be stored, but will be absorbed, resulting in a small gain in heat energy within the molecule.

If the entering photonic energy did cause the Chromophores (100) and (110), and the associated single-double bonds (120) and (130) to resonate with captured energy, then the dye molecule, in a quest to become more stable, will soon employ the resonate energy within the molecule to create and emit a photon with a wavelength (color) of light centered at the wavelength on the Chromophores (100) and (110).

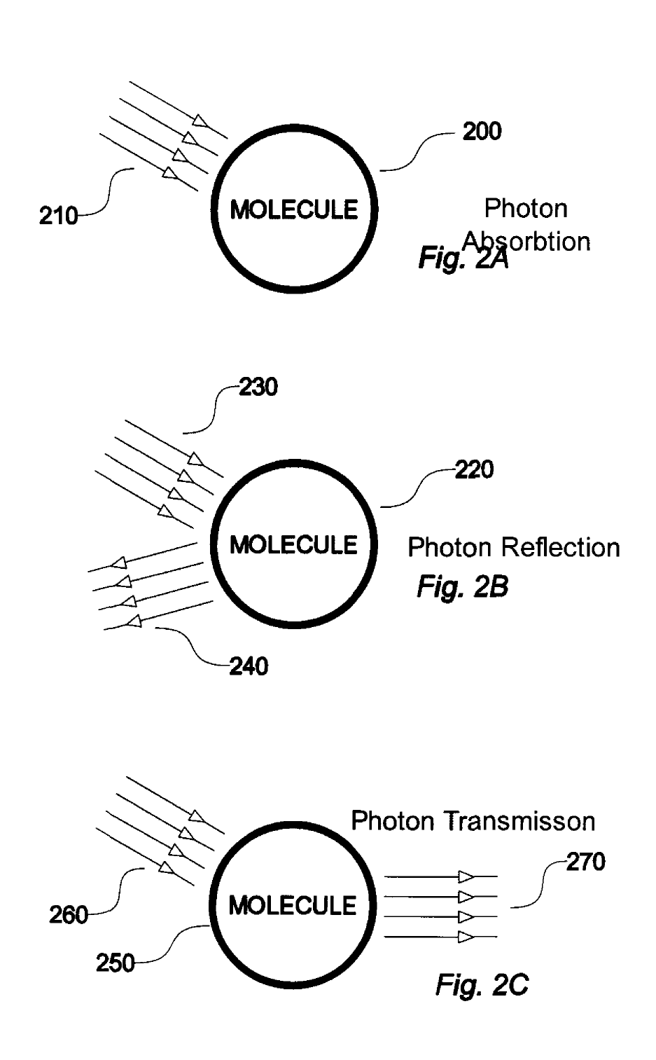

FIG. 2A is an overview illustration of one of the three possible results of a dye molecule being energized or struck by a photon (most likely as part of a light ray, made up of a multiplicity of photons): Photon Absorption. In FIG. 2A, molecule (200) is struck by light rays (210). This FIG. 2A represents the reaction of a dye molecule to photonic energy that is received, that is outside of the tuned wavelength range of the Chromophores. That is, in FIG. 2A, the photonic energy within the light rays (210) is simply absorbed by the molecule (200), which in turn results in an increase of heat within molecule (200). No output or redirection of optical energy will occur, and molecule (200) will appear dark to the human eye.

FIG. 2B is an overview illustration of the second of the three possible results of a dye molecule being energized or struck by a photon: Photon Reflection. In FIG. 2B, molecule (220) is struck by light rays (230). The light rays are reflected, and the reflected light rays (240) are emitted away from the molecule. Note that differing from FIG. 2C below, the photonic energy is not absorbed by the molecule. Reflection happens most often when the wavelength or wavelength of the incoming photon is at, or near the outer edges of the spectrum of wavelengths the dye molecule Chromophores are tuned to.

FIG. 2C is an overview illustration of the third of the three possible results of a dye molecule being energized or struck by a photon. Indeed, the same optical process that was addressed in depth by FIG. 1: Photon Transmission (sometimes referred to as “Photon Retransmission”). In FIG. 2C, molecule (250) is struck by light rays (260). These light rays are then absorbed by the molecule, and later newly generated light rays (270) are emitted elsewhere from the dye molecule. FIG. 2C (photon transmission), is the preferred method of generating photons for the invention.

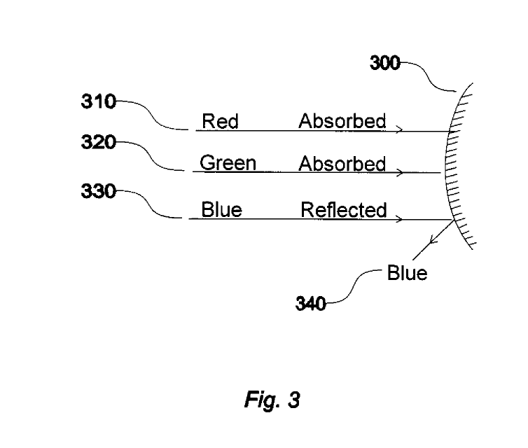

FIG. 3 is an illustration of the same type of dye molecule (300) suspended in a liquid, such as water or soda, wherein the liquid is illuminated with Red, Green and Blue LEDs as generally used as a “White LED” light source in drink containers.

In FIG. 3, the Red-light photons in the form of rays (310) are emitted from the Red LED located in the base of the container are absorbed into the Blue dye molecule (300) and not re-emitted or reflected, because their wavelength (605-700 nanometers) is outside of the band of acceptable Blue wavelengths (435-480 nanometers) of the Chromophores. Therefore, the dye molecule (300) absorbs the Red photonic energy as heat, and no Red optical energy is released or distributed.

In a similar fashion, the Green light photons in the form of rays (320) are emitted from the Green LED located inside or outside of the base of the container and are absorbed into the Blue dye molecule (300) and not re-emitted or reflected, because their wavelength (500-560 nanometers) is also outside of the band of acceptable Blue wavelengths (435-480 nanometers) of the Chromophores.

Finally in FIG. 3 the Blue light rays (330) from the Blue LED located in the base of the container are absorbed into the dye molecule (300) and being within the bandwidth of acceptable optical wavelengths (435-480 nanometers) is reflected or retransmitted out of the dye molecule (300) as a photon or light ray (340). Therefore, the dye molecule (300) creates the desired appearance that the liquid itself is glowing Blue.

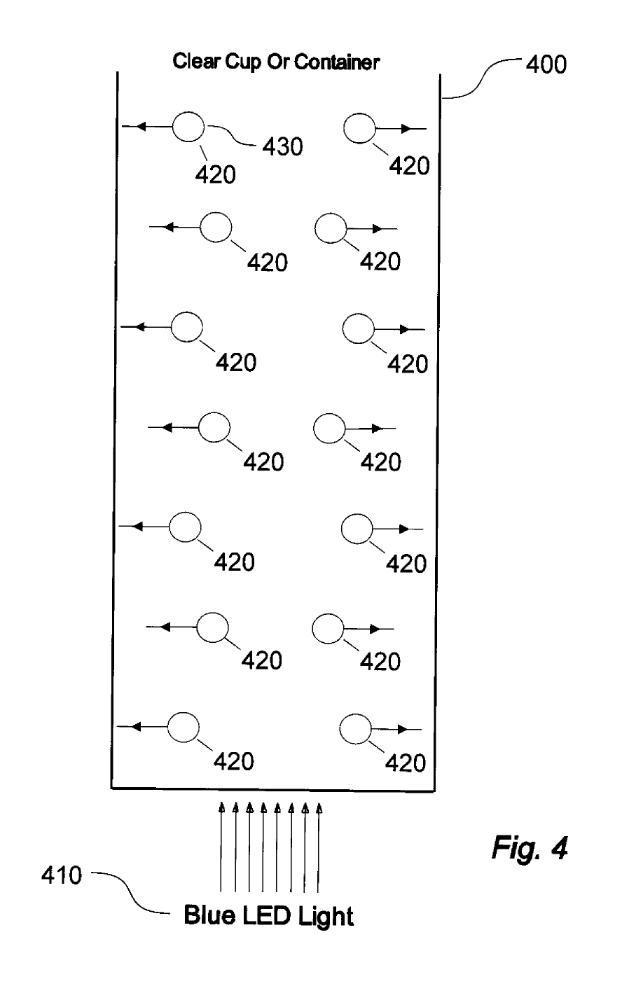

FIG. 4 is an illustration of a container (400) with a water-based liquid wherein a plethora of Blue Dye Molecules (420) are introduced into the container with the water-based liquid. The goal of this embodiment is to create the appearance of a drink container filled with a glowing Blue drink. In this instance a single-color light source (410) of Blue LEDs is used in order to increase efficiency, as generating all three primary colors when only one primary color is targeted would waste battery power. The photonic energy of the LED array (410) is focused from the bottom of the container (400) and aimed towards the top lid area of the container (400).

As the photonic energy of the LED array travels up towards the lid (“top”) of container (400), photonic energy will impact numerous dye molecules (420) which in turn will reflect or retransmit Blue Photonic energy (430) creating the desired appearance of the water-based liquid “glowing” Blue.

Any color can be presented to the user of the cup or container. By utilizing a different primary color source other than Blue, or a mixture of primary color sources (which might include Blue), any color in the visible spectrum can be created using the same techniques as described herein above.

For example, and not by means of limitation to a single primary color, if a Red LED is substituted for the Blue LED that comprises the light source (410) in FIG. 4, and if Red Dye molecules are substituted for the Blue Dye molecules (420) also in FIG. 4, then the liquid in the container will glow Red.

As a further example, if both a Red LED and a Blue LED are operated as light sources, and if both Red dye molecules and Blue dye molecules are present in the liquid, then the drink can be made to glow Violet. Indeed, varying the brightness of the LED or light sources as individual light means, then the liquid can be made to glow Red or Blue, or any shade of Red-Blue color (such as violet as an example).

Further still, if all three primary light colors (Red, Green, and Blue) are operated as light sources (or as one or more single RGB LED's), and if properly selected Red dye molecules and Green dye molecules, and Blue dye molecules are present in the liquid, then the drink can be made to glow any color (from approximately 400 to 700 nanometers) of the visible light spectrum. Depending on the LED light source control scheme, the contents of the container can be displayed as a single static color, as a slowly-changing color or as a rapidly-changing color.

The practical limitation for an acceptable visual display being the quantity of dye molecules in the liquid and their mix both by color and by photonic mode. Taking naturally existing liquids, such as water, fruit juices, etc., or one that is accepted by many as quasi-natural, such as beers, wines, etc., or common off-the-shelf, name brand carbonated beverages such as Cola drinks from Coke, or Pepsi, Orange Crush, etc., some of these liquids are suitable for providing for a medium with an acceptable visual presentation.

As an example, in the category of wines, both White Wines and Rose Wines present an acceptable visual display. With the proper light source, given that these liquids possess natural dyes that are predominately photon transmissive (as illustrated in FIG. 2C) and the density of the dye and other molecules is not so great that the molecules become an impediment to the light reaching the top of the container at a sufficient intensity for the effect to work. Red wines however fail to produce an acceptable display as the density of their dye molecules and other static molecules is too high to facilitate transmission beyond much more than an inch up the container. The other constituent molecules, such as sugars, acids, enzymes, and other nutrients do not reflect or retransmit photons but only absorb them, further frustrating an acceptable display.

Colas and Dark Coffees present a very poor medium for the targeted glow effect. In the case of Colas and Dark Coffee, their density is not the only primary limiting factor, as the color “Brown” itself is not conducive to production or even detection as a color of light. On the other hand, other colored sodas such as Orange Crush provide quite acceptable visual displays even with lower intensity light sources.

Some Lighter Coffees and Teas present a viable medium for acceptable visual displays so long as the height of the liquid is limited. However, adding milk or cream to the drink, because of the high-density of light-absorbing molecules, blocks the transmission of light, and blocks the lighting effect entirely. The same can be said of some alcoholic bar drinks. Some clear colored drinks can be used to generate the glowing effect, while others (e.g. those predominately made of crushed ice, made with cream, or dark brown in color) cannot.

Fluorescing dyes with UV or Near-UV (Dark Blue to Purple) light sources, such as LEDs or OLEDs (Organic Light Emitting Diodes) may be used for visual displays. As an example, a clear liquid drink (e.g. water with sugar and light citrus flavoring, etc.) can have a dye added that is clear without UV or Near-UV photonic excitation. When the UV or Near-UV light source is on, the dye becomes excited and glows a color other than UV or Near-UV. Several fluorescent dyes exist in nature and are known to be safe for human consumption and approved by the FDA.

Light sources that change color by manual or automatic means such as a light controller circuit following a programmed color pattern, that has abrupt changes, or gently faded up and down to create a color-morphing effect. There can be a steady light source, or a flashing light source in patterns that are slow enough for the flash pattern to be visible to humans, in order to stimulate interest in the light.

Furthermore, the light source can be static, fading between colors or lighting levels, or flashing. If flashing, the light source can be flashed at rates that are perceptible, or not perceptible to humans. Non-perceived optical flash rates are usable in certain mood and therapeutic applications.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

What is claimed is:

1. A method for creating the appearance of a glowing liquid in a drinking container by placing a liquid into the container, placing a light source proximate to the container, placing a plurality of dye molecules into the container, the light source emitting photons, which are absorbed into the dye molecules which creates the appearance that the liquid itself is glowing.

2. The method for creating the appearance of a glowing liquid in a drinking container of claim 1 in which the light source is in the container.

3. The method for creating the appearance of a glowing liquid in a drinking container of claim 1 in which the light source is attached to the container.

4. The method for creating the appearance of a glowing liquid in a drinking container of claim 1 in which the light source is an LED.

5. The method for creating the appearance of a glowing liquid in a drinking container of claim 1 in which the dye molecules have wavelengths which absorb photons emitted from the light source.

6. The method for creating the appearance of a glowing liquid in a drinking container of claim 1 in which the dye molecules contain chromophores that receive photonic energy within the dye molecule.

7. The method for creating the appearance of a glowing liquid in a drinking container of claim 4 in which photons or light rays from the LED are absorbed into the dye molecules and are transmitted out of the dye molecules as photons or light rays into the container creating the appearance of a glowing liquid.

8. The method for creating the appearance of a glowing liquid in a drinking container of claim 5 in which the photons or light rays from the LED are absorbed into the dye molecules being within the acceptable optical wavelength of the molecule.

9. The method for creating the appearance of a glowing liquid in a drinking container of claim 5 in which the glowing liquid is a single color or a combination of colors.

10. The method for creating the appearance of a glowing liquid in a drinking container of claim 7 in which all three primary light colors, Red, Green, and Blue are operated as one or more light sources and Red dye molecules, Green dye molecules, and Blue dye molecules are present in the liquid, and the drink can be made to glow any color from 400 to 700 nanometers of the visible light spectrum.

11. The method for creating the appearance of a glowing liquid in a drinking container of claim 10, in which the LED light source control scheme, controls the contents of the container to be displayed as a single static color, as a slowly-changing color or as a rapidly-changing color.

12. The method for creating the appearance of a glowing liquid of claim 1, in which the light source employs an optical flash-rate that is perceptible to humans.

13. The method for creating the appearance of a glowing liquid of claim 1, in which the light source employs an optical flash-rate that is not perceptible to humans.

14. The method for creating the appearance of a glowing liquid of claim 1, in which the light source employs color changing.

15. A method for creating the appearance of a glowing liquid in a drinking container by placing a liquid into the container, placing an LED light source proximate to the container, placing a plurality of dye molecules into the container, the LED light source emitting photons, which are absorbed into the dye molecules, in which all three primary light colors, Red, Green, and Blue are operated as one or more light sources and Red dye molecules, Green dye molecules, and Blue dye molecules are present in the liquid, and the drink can be made to glow any color from 400 to 700 nanometers of the visible light spectrum, which creates the appearance that the liquid itself is glowing.

16. The method for creating the appearance of a glowing liquid in a drinking container of claim 15, in which the LED light source can control the contents of the container which can be displayed as a single static color, as a slowly-changing color or as a rapidly-changing color.

17. The method for creating the appearance of a glowing liquid in a drinking container of claim 15 in which the LED is in the container.

18. The method for creating the appearance of a glowing liquid in a drinking container of claim 15 in which the LED is attached to the container.

19. The method for creating the appearance of a glowing liquid in a drinking container of claim 15 in which the dye molecules contain chromophores that receive photonic energy within the dye molecule.

20. The method for creating the appearance of a glowing liquid of claim 15, in which the LED employs color changing.
